(19) United States
(12) Patent Application Publication
(10) Pub. No.: US 2013/0113649 A1
(43) Pub. Date: May 9, 2013

(54) DETECTION OF AN ASYMMETRIC OBJECT

(71) Applicants: Marquette Trishaun, Orlando, FL (US); Douglas O. Carlson, Winter Garden, FL (US)

(72) Inventors: Marquette Trishaun, Orlando, FL (US); Douglas O. Carlson, Winter Garden, FL (US)

(21) Appl. No.: 13/672,867

(22) Filed: Nov. 9, 2012

Related U.S. Application Data
(60) Provisional application No. 61/557,670, filed on Nov. 9, 2011.

(51) Int. Cl. G01S 13/04

(52) U.S. Cl. CPC G01S 13/04
USPC 342/22

(57) ABSTRACT

An apparatus for detecting objects includes a transceiver configured to generate a radar signal, a transmit antenna coupled to the transceiver and configured to emit the radar signal, the radar signal comprising a first circular polarization, and a receive antenna coupled to the transceiver and configured to receive a return signal, the return signal comprising the first circular polarization.

### CROSS-REFERENCE TO RELATED APPLICATIONS

The present application claims priority from U.S. Provisional Application Ser. No. 61/557,670, filed Nov. 9, 2011, and entitled “DETECTION OF AN ASYMMETRIC OBJECT”. The contents of the prior application are incorporated herein by reference in their entirety.

### TECHNICAL FIELD

This disclosure relates detection of an asymmetric object.

### BACKGROUND

A large percentage of buried explosive devices contain some amount of metal. Many versions of buried explosive devices use metal for firing pins, shrapnel, and portions of the casing. If a buried explosive device has a sufficient quantity of a detectable metal, that buried explosive device can be found using a metal detector.

### SUMMARY

This disclosure relates to detecting asymmetric objects. In some implementations, an apparatus for detecting objects includes a transceiver configured to generate a radar signal, a transmit antenna coupled to the transceiver and configured to emit the radar signal, the radar signal comprising a first circular polarization, and a receive antenna coupled to the transceiver and configured to receive a return signal, the return signal comprising the first circular polarization.

In some implementations, the transmit antenna and the receive antenna are a single antenna.

In some implementations, the transceiver comprises a directional coupler configured to access the received return signal.

In some implementations, the directional coupler is configured to access an amplitude and a phase of the received return signal.

In some implementations, the transceiver is electrically coupled to the transmit antenna through an electrically conductive trace, and the directional coupler comprises an electrically conducting element positioned to be electromagnetically coupled to the electrically conductive trace when current flows through the electrically conductive trace.

In some implementations, the apparatus includes an additional receive antenna coupled to the transceiver and configured to receive another return signal, the another return signal comprising a second circular polarization different from the first circular polarization.

In some implementations, a method of operating a radar system includes generating, by a transceiver, a radar signal, emitting the radar signal towards a surface, the radar signal comprising a first circular polarization, receiving a return signal from the object surface, the return signal comprising the first circular polarization, and identifying, from the received return signal, the presence of a target object, the target object being a substantially asymmetric object located beneath a ground surface.

In some implementations, the object is a substantially asymmetric object.

In some implementations, the substantially asymmetric object is a command wire.

In some implementations, the method includes receiving another return signal from the surface, the received another return signal comprising a second circular polarization opposite from the first circular polarization.

In some implementations, a method for detecting asymmetric objects includes accessing, using an electronic processor coupled to a transceiver, data representing radar return signals arising from one or more pulses emitted from a radar system, analyzing, using the electronic processor, the accessed data to identify a target object, determining, using the electronic processor and based upon the analyzed accessed data, that the target object is (i) a substantially asymmetric objected is located beneath a ground surface, or (ii) other than a substantially asymmetric objected is located beneath a ground surface, and in response to determining that the target object is (i) a substantially asymmetric objected is located beneath a ground surface, or (ii) other than a substantially asymmetric objected is located beneath a ground surface, generating, using the electronic processor, an alarm to an operator.

In some implementations, the data representing radar return signals comprises a ground penetrating radar data packet.

In some implementations, analyzing, using the electronic processor, the accessed data to determine whether a substantially asymmetric object is located beneath a ground surface includes establishing a threshold based upon the accessed data, filtering the accessed data based upon the threshold, filtering the threshold filtered accessed data using a morphological filter, and presenting the alarm to the operator based upon the morphological filtered, threshold filtered accessed data.

In some implementations, determining, using the electronic processor and based upon the analyzed accessed data, that the target object is (i) a substantially asymmetric objected is located beneath a ground surface, or (ii) other than a substantially asymmetric objected is located beneath a ground surface includes establishing a threshold based upon the accessed data, comparing the accessed data with the threshold, and determining, based upon results of the comparing the accessed data with the threshold, the presence of the target object.

In some implementations, the method includes determining, based upon results of comparing the accessed data with the threshold, that the accessed data is above the threshold, determining, based upon the determination that the access data is above the threshold, that the target object is a substantially asymmetric object, and generating, based upon the determining that the target object is a substantially asymmetric object, the alarm to an operator that the target object is a substantially asymmetric objected located beneath a ground surface.

In some implementations, the method includes determining, based upon results of comparing the accessed data with the threshold, that the accessed data is below the threshold, determining, based upon the determination that the access data is above the threshold, that the target object is not a substantially asymmetric object, and preventing generation, based upon the determining that the target object is a substantially asymmetric object, of the alarm to the operator that the target object is other than a substantially asymmetric objected located beneath a ground surface.

In some implementations, a system includes one or more computers and one or more storage devices storing instructions that are operable, when executed by the one or more computers, to cause the one or more computers to perform operations of generating, by a transceiver, a radar signal, emitting the radar signal towards a surface, the radar signal comprising a first circular polarization, receiving a return signal from the object surface, the return signal comprising the first circular polarization, and determining, from the received return signal, whether an object is obscured by the surface.

In some implementations, the operations include accessing the received return signal using a directional coupler to access an amplitude and a phase of the received return signal.

In some implementations, the operations include receiving another return signal using an additional receive antenna coupled to the transceiver, the another return signal comprising a second circular polarization different from the first circular polarization.

In some implementations, the transceiver is electrically coupled to the transmit antenna through an electrically conductive trace, and the directional coupler comprises an electrically conducting element positioned to be electromagnetically coupled to the electrically conductive trace when current flows through the electrically conductive trace.

### BRIEF DESCRIPTION OF THE DRAWINGS

FIG. 1 shows an exemplary system configured for detecting objects.

FIGS. 2A and 2B show schematics of an exemplary transceiver configured for use in the system of FIG. 1.

FIGS. 3A and 3B show exemplary visualizations of detections of substantially elongated or radially asymmetric objects.

FIGS. 4A and 4B show exemplary processes for detecting an asymmetric object.

FIG. 5A shows an exemplary portable system for detecting objects.

FIG. 5B shows an exemplary sensor head configured for use in the system of FIG. 5A.

### DETAILED DESCRIPTION

A detection system for scanning a region is disclosed. The detection system may be, for example, a system that transmits and receives radar signals. The region may be, for example, the surface and subsurface of the ground or a space in the vicinity of a stationary portal through which persons and objects (such as luggage and cargo) pass. The region may be all or a portion of a person who is scanned with the detection system by a human operator. The detection system may be used to detect buried explosive devices, e.g., landmines, and/or bulk explosives that are not necessarily included in explosive devices. The system also may be used to detect metallic objects, such as small wires, objects that may or may not include metal, such as improvised explosive devices (IEDs), and non-metallic objects, such as explosives that are buried in the ground or obscured by, for example, being hidden on the body of a person.

The detection system may include a radar system configured to operate in one of a mono-static detector mode and a bi-static detector mode. In some implementations, either of the mono-static detector mode and the bi-static detector mode is used alone. In some implementations, the mono-static detector mode and the bi-static detector mode may be used simultaneously or concurrently. The radar system may include a transmit antenna and a receive antenna. For example, in the bi-static detector mode, the radar system is configured to transmit or emit a radar signal from the transmit antenna and receive a return radar signal at the receive antenna. In the mono-static detector mode, the radar system is configured to transmit the radar signal and receive the return radar signal on the same antenna. For example, the radar system is configured to transmit the radar signal from the transmit antenna and receive the return radar signal on the transmit antenna.

The mono-static detector mode may be configured to detect objects that have an asymmetric profile or shape, such as wires, command wires, and pipes. The mono-static detector mode enhances the signature of the asymmetric object while simultaneously reducing signals corresponding to ground clutter. As discussed below, the mono-static detector mode makes use of different polarization effects of the radar system antennas with regard to the ground and the asymmetric object, and uses the differences in polarization effects to improve the detection of the asymmetric object.

For example, a radar system is configured to transmit a radar signal toward the surface of the ground to detect objects on, below, or extending into the ground surface. The radar signal returned or reflected from a ground/air interface has a polarity that is opposite to the polarity of the transmitted radar signal. The radar signal reflected from the asymmetric object includes different polarization components. In some implementations, the radar signal reflected from the asymmetric object includes a first polarization component having the same polarization as the transmitted radar signal emitted toward the ground surface, and a second polarization component having a polarization different than the transmitted radar signal emitted toward the ground. By detecting the radar signal reflected from the asymmetric object that has the same polarization as a transmitted radar signal emitted toward the ground surface, radar signals attributable to the reflection from the ground surface can be eliminated while the radar signals attributable to the reflection from the asymmetric object are retained.

In some implementations, the radar system includes a transmit antenna (or emitting antenna) that is left-hand circular polarized (LHCP), and a receive antenna that is right-hand circular polarized (RHCP). Using opposing circular polarizations of the transmit and receive antennas enhances detection of particular types of buried objects. However, reflected radar signals (i.e., radar returns) of small, asymmetric objects, such as buried wires, can be obscured by radar signals associated with ground clutter because both the buried wire and the ground surface produce a RHCP signal that is detected by the receive antenna. Although both the air/ground interface and the asymmetric object produce a radar return comprising a RHCP signal, the asymmetric object also produces a radar return comprising a LHCP signal. Thus, by transmitting (emitting) radar signal and receiving radar return signals using the same LHCP antenna in mono-static detector mode, radar return signals corresponding to ground clutter can be substantially removed or reduced to yield radar data corresponding to the asymmetric object.

In some implementations, an existing bi-static detector mode radar system may be retrofitted and transformed into one of a dual mono-static detector system and a bi-static detector mode system. For example, by adding a directional coupler to tap off, or otherwise access, a return signal received by the transmit antenna, a bi-static detector mode radar system may be transformed into a dual mono-static detector system or a bi-static detector mode system.

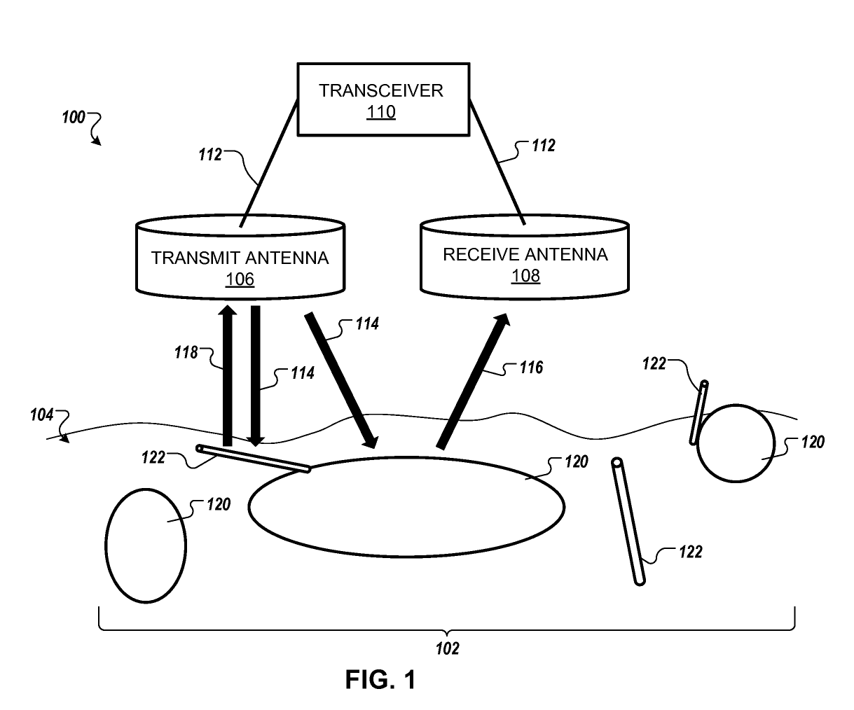

FIG. 1 shows an exemplary system 100 configured for detecting objects 102. The objects 102 can be obscured, overlayed, covered, buried, or otherwise not readily apparent to a human observer looking at the ground surface 104. In the example shown in FIG. 1, the objects 102 are partially or completely submerged beneath the ground surface 104. In some implementations, the system 100 is configured to include a transmit antenna 106 and a receive antenna 108 coupled to a transceiver device 110. In some implementations, the transceiver device 110 is configured to be electrically connected to the transmit antenna 106 and the receive antenna 108 using conductive members 112, for example. The transceiver device 110 is configured to send signals to and receive signals from the transmit antenna 106 and the receive antenna 108. In some implementations, the system 100 is configured to operate in one of a mono-static detector mode and a bi-static detector mode. In other implementations, the system 100 is configured to operate in both a mono-static detector mode and a bi-static detector mode, as described further below.

In some implementations, the transmit antenna 106 is configured to emit a circularly polarized transmit signal 114 toward the ground surface 104 with the transmit signal 114 and the transmit antenna 106 having the same chirality or handedness. For example, if the transmit antenna 106 is left-hand circular polarized (LHCP), then the polarized transmit signal 114 is also LHCP. Alternatively, if the transmit antenna 106 is right-hand circular polarized (RHCP), then the polarized transmit signal 114 is also RHCP.

The receive antenna 108 is configured to have an opposite chirality, as compared to the transmit antenna 106. Accordingly, the receive antenna 108 is configured to receive a receive signal 116 having the same chirality as the receive antenna 108 (and an opposite chirality as the transmit antenna 106 and the transmit signal 114). The transmit signal 114 reflects off the ground surface 104 or objects 102, or both the ground surface 104 and objects 102, and is transformed into the receive signal 116. As described further below, objects 102 having particular types of shapes can cause the transmit signal 114 to reflect off the objects 102 and transformed into a receive signal 118, which may include different polarized components compared to the receive signal 116.

In some implementations, the system 100 is configured to operate in either or both of a bi-static detector mode and a mono-static detector mode. For example, in the bi-static detector mode, transmit radar signals 114 are transmitted from the transmit antenna 106, transformed into reflected receive signals 116 that reflect off of the objects 120, and the reflected receive signals 116 are received by the receive antenna 108. When the transmit signal 114 reflects off of the ground surface 104, or off a radially symmetric object, the chirality of the transmit signal 114 is transformed into the reflected receive signal 116 having a chirality opposite to the chirality of the transmit signal 114. For example, if the transmit signal 114 is LHCP, then the receive signal 116, which is reflected off of the ground surface 104, is RHCP. In addition, the objects 102, which may be partially or completed buried beneath the ground surface 104, also reflect the transmit signal 114, and the receive signal 116, which is reflected from the objects 102, also includes a RHCP component. In some implementations, the transceiver 110 is configured to receive (or detect) the receive signal 116 at the receive antenna 108 and determine, for example, whether the detected objects 120 is an explosive mine or other type of explosive device. For example, the detected objects 120 which may have substantially round or radially symmetric shapes, are obscured and not visible above the ground surface 104.

In the mono-static detector mode, radar signals are transmitted and received by the same antenna, such as the transmit antenna 106. When the transmit signal 114 is reflected off of a substantially elongated or radially asymmetric object, such as objects 122, i.e., thin wires, a reflected receive signal 118 is generated that includes both LHCP and RHCP components. Accordingly, the receive antenna 108 is configured to receive a portion of the receive signal 118 that has the same chirality as the receive antenna 108 (RHCP), and the transmit antenna 106 can receive a portion of the receive signal 118 that has the same chirality as the transmit antenna 106 (LHCP). Because only the receive signal 118 reflecting off of a substantially elongated or radially asymmetric object, such as object 122, includes a portion of the radar signal that has the same chirality as the transmit antenna 106, the transceiver 110 is configured to receive, by the transmit antenna 106, a reflected signal that corresponds to the object 122 without also receiving a reflected signal 116 that corresponds to, for example, the ground surface 104.

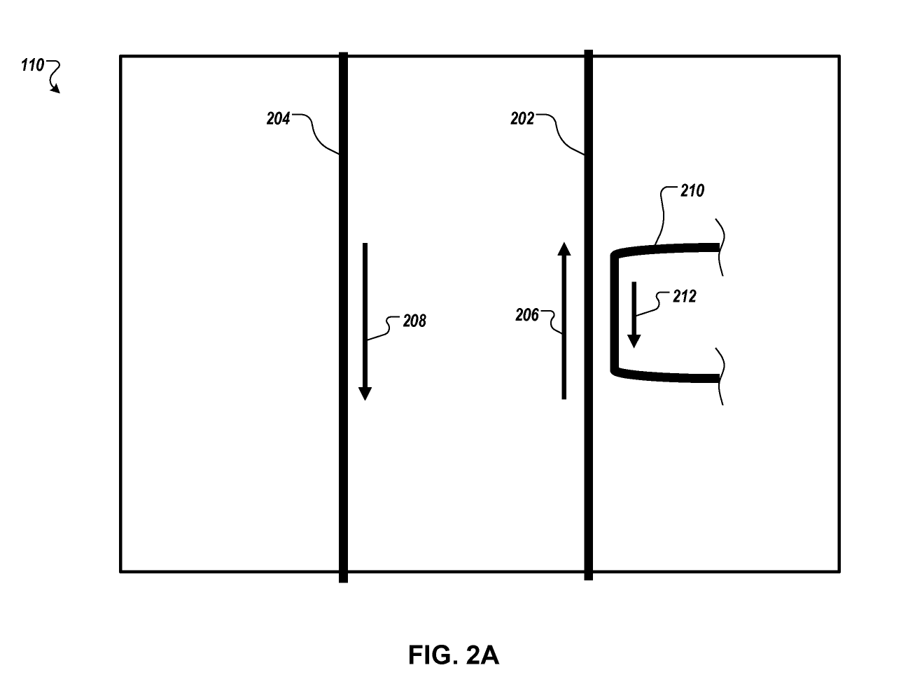

FIG. 2A shows a schematic of an exemplary transceiver 110 configured for use in the system 100. The transceiver 110 is configured to include a transmit line 202 and a receive line 204. In some implementations, the transmit line 202 is electrically coupled to the transmit antenna 106 (in FIG. 1), and the receive line 204 is electrically coupled to the receive antenna 108 (in FIG. 1). In FIG. 2, a signal travels through the transmit line 202 along a direction 206 to the transmit antenna 106 (in FIG. 1), and is emitted as transmit signal 114. Similarly, the receive signal 116 (in FIG. 1) is received (or detected) by the receive antenna 108 (in FIG. 1) and travels through the receive line 204 in a direction 208. In some implementations, the transmit line 202 and the receive line 204 are electrically coupled to an electronics module (not shown). For example, the electronics module is configured to include an electronic processor coupled to a computer-readable storage medium.

As shown in FIG. 1, a portion of the receive signal 118 is received by the transmit antenna 106, and travels through the transmit line 202 in the direction 212 where it is detected (or absorbed, accessed, captured, tapped off, or the like) by a directional coupler 210. In some implementations, the directional coupler 210 is a trace line positioned in substantial proximity to the transmit line 202. For example, the directional coupler 210 is configured to have a spatial position relative to the transmit line 202. Accordingly, when a current flows through the transmit line 202, a magnetic field generated by the current flowing in the transmit line 202 induces a corresponding current 217 in the directional coupler 210 that flows along a direction 212. For example, the corresponding current 217 includes a signal that represents amplitude and phase (I/Q) of the receive signal 118 that is flowing through the transmit line 202.

In some implementations, the directional coupler 210 is configured to allow the transmit antenna 106 to receive signals and operate in a mono-static detector mode. In some implementations, the directional coupler 210 is configured to be added into a transceiver of an existing bi-static radar system in order to reconfigure the bi-static radar system into a dual mono-static and bi-static radar system.

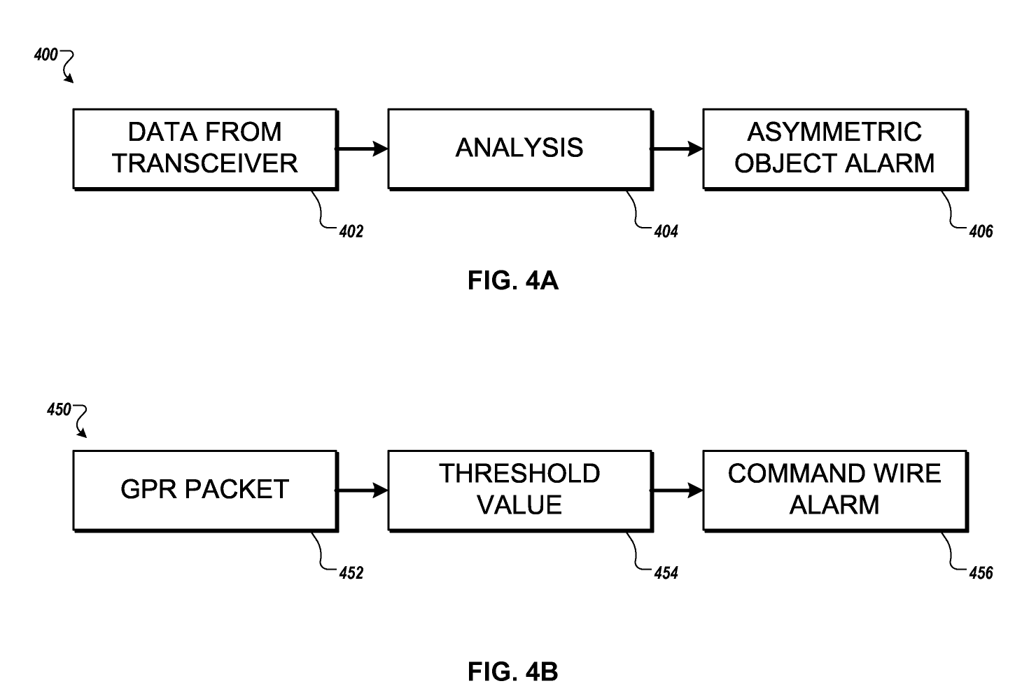

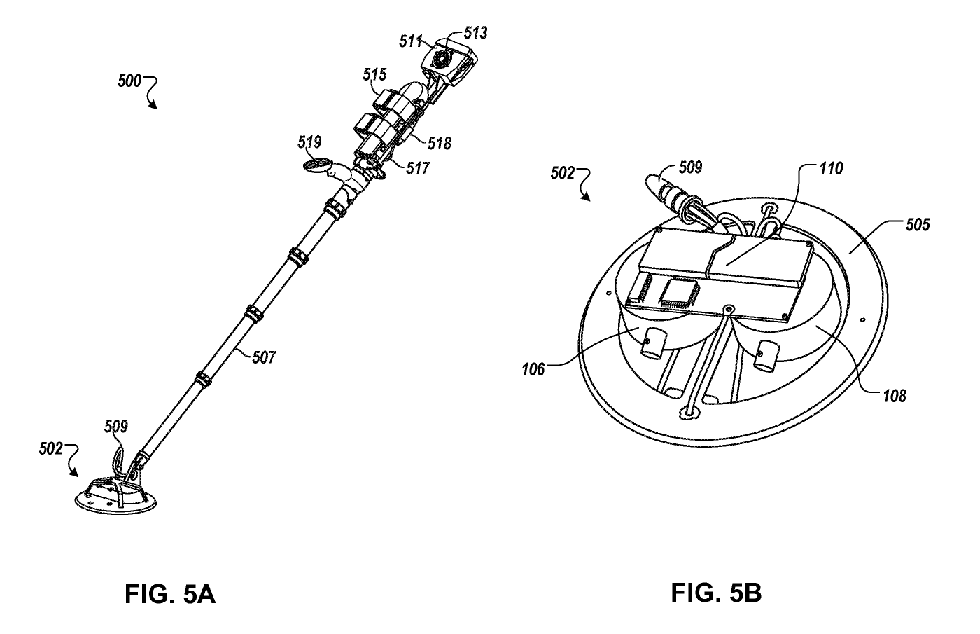

FIG. 2B shows another exemplary transceiver 110B configured for use in the system 100. In the transceiver 110B, the corresponding current 217 that is accessed using the directional coupler 210 comprises a signal 217 that represents amplitude and phase (I and Q) of the receive signal 118 that flows through the transmit line 202. The transceiver 110B is configured to include a double balanced mixer 225 in conjunction with a 90 degree hybrid for the measurement of both in-phase 230 and quadrature 235 of reflected energy as reflected back via the directional coupler 110 (in FIG. 2A). The in-phase 230 and quadrature 235 signals are output to analog-to-digital converters (ADCs) 240, 245 respectively. This implementation allows for measurement of a signal flowing through the transmit line 202 in coherent fashion and may be used, for example, with continuous wave radars. In some implementations, the transceiver 110B may be configured for use in the exemplary systems shown in FIGS. 1, 5A, and 5B.

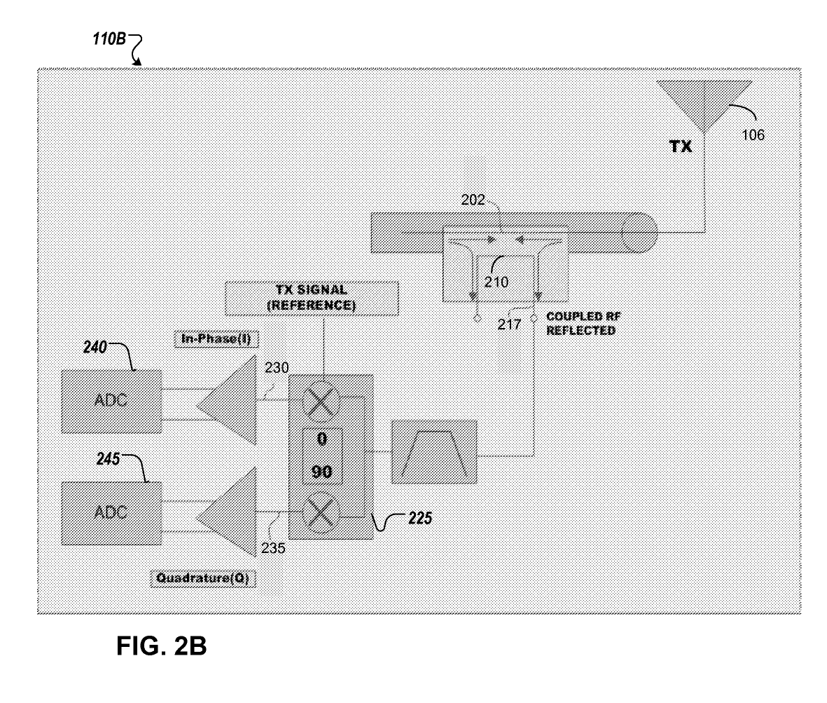

FIGS. 3A and 3B show exemplary visualization plots 300, 302. The visualization plots 300, 302 illustrate, respectively, detection of substantially elongated or radially asymmetric object, such as object 122 (in FIG. 1), based on the receive signal 116 and the receive signal 118, respectively. The plot 300 is an exemplary visualization of data captured in the bi-static detector mode, and the plot 302 is and exemplary visualization of data captured in the mono-static detector mode. In the bi-static detector mode plot 300, the object 122 cannot be readily discerned from the relatively large amount of ground clutter 304. In contrast, the mono-static detector mode plot 302 shows a signal 306 corresponding to the object 122. Because signal reflecting off of the ground surface 104 is of an opposite chirality as the transmit antenna 106, ground clutter 304 is generally absent from the mono-static detector mode plot 302.

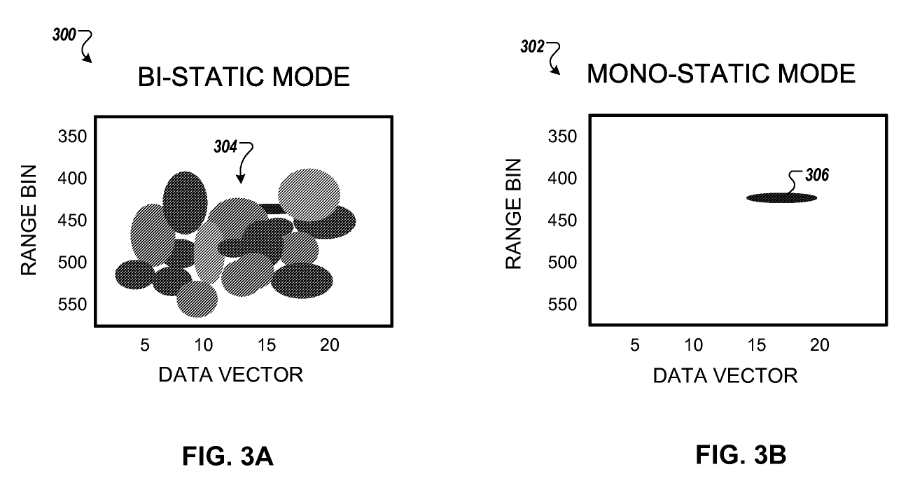

FIGS. 4A and 4B show exemplary processes for detecting an asymmetric object. FIG. 4A shows an exemplary process 400 for detecting a substantially elongated or radially asymmetric object, such as object 122 (in FIG. 1). In some implementations, the process 400 can be performed by, for example, one or more processors (not shown) electrically coupled to the transceiver 110 (in FIG. 1). In some implementations, the process 400 may be performed by an electronic processor (not shown) that is included on the transceiver 110 (in FIG. 1).

In FIG. 4A, data is accessed from the transceiver 110 (402). In some implementations, the data may be a ground penetrating radar (GPR) data packet that represents radar returns arising from one or more pulses emitted from a stepped-frequency continuous wave (SFCW) radar system. For example, data represented by plots 300, 302 (in FIGS. 3A and 3B) are exemplary of data that may be accessed from the transceiver 110.

The accessed data is analyzed (404). In some implementations, the analysis determines whether a substantially asymmetric object, such as object 122, is present under the ground surface 104. For example, an object is considered to be detected when the accessed data indicates that the object is present. In some implementations, the analysis may include one or more of a threshold on the accessed data or a portion of the accessed data, a threshold filter applied to the accessed data, and/or morphological (shape) filters applied to the accessed data.

If a substantially asymmetric object is detected, then an alarm is presented (406). In some implementations, the alarm may be a visual and/or audio alarm that is presented to an operator of the system 100 to notify the operator of detection of the object. In some implementations, the alarm may be an electronic notification to an autonomous and/or electronic process. For example, the alarm may include a visualization, such as that shown in FIGS. 3A and 3B.

In FIG. 4B, an exemplary process 450 illustrates an implementation of the process 400 to detect the presence of a thin wire object, such as a wire having a gauge of greater than 26, with a ground penetrating radar (GPR). A GPR packet is accessed (452). In some implementations, the GPR packet is accessed by being retrieved from an electronic storage on the transceiver 110 (in FIG. 1) and/or by receiving the GPR packet directly from the transceiver 110 (in FIG. 1).

A threshold is applied to the GPR packet (454). In some implementations, the threshold is a predetermined value that indicates, for data points having a value below the threshold, that the data point is more likely than not to represent clutter other than the thin wire object. In some implementations, the threshold is a predetermined value that indicates, for data points having a value above the threshold, that the data point is more likely than not to represent a thin wire object.

A command wire alarm is produced if one or more data points exceed the threshold (456). In some implementations, the command wire alarm may be a visually and/or audio perceivable alarm that is presented to an operator of the system 100 to notify the operator of detection of the thin wire object. In some implementations, the alarm may be an electronic notification to an autonomous and/or electronic process. For example, the alarm may include a visualization, such as that shown in FIGS. 3A and 3B.

In some implementations, the techniques described above may be incorporated and used for explosive mine detection, and may be used in a system that includes a multi-sensor sensor head, is lightweight, portable (by, for example, being capable of being hand-carried and/or wearable on the body), and has a rugged design and construction configured to withstand various different impacts and extreme climate conditions (i.e., high winds, heavy or light rain, snow, ice, and sand).

In some implementations, the sensor head may be configured to include radar antennas that transmit and receive electromagnetic radiation and are electrically coupled to a transceiver. For example, the radar antennas may be part of a ground penetrating radar (GPR) system, and the transceiver may be integrated into the sensor head or may be located upon the sensor head. In some implementations, the transceiver is configured to be located separate from the sensor head, but is in communication with the sensor head. For example, the transceiver may be located in an electronics unit or an electronics housing that is coupled to a wand that is attached to the sensor head.

In some implementations, the sensor head also may be configured to include a continuous-wave metal detector (CWMD). For example, the dynamic range of the CWMD allows the GPR and electronics associated with the GPR to be: (1) housed in the sensor head with the CWMD; (2) integrated into the sensor head along with the CWMD; or (3) otherwise placed substantially near (i.e., about one foot or less) the CWMD. Due to the dynamic range of the CWMD, the CWMD (or data from the CWMD) may be configured to be adjusted or otherwise compensated to account for the metal in the transceiver, whereas pulsed metal detectors generally cannot be compensated. The ability of the CWMD to adjust to the transceiver metal allows for the transceiver to be placed within the sensor head or substantially near the sensor head. Moreover, a CWMD may be configured to detect items that a typical pulsed metal detector is not capable to detect, such as non-ferrous metals.

FIG. 5A shows an exemplary portable system for detecting objects, and FIG. 5B shows an exemplary sensor head configured for use in the system of FIG. 5A. In FIGS. 5A and 5B, system 500 is configured to include the transceiver 110 in a sensor head 502. In FIG. 5A, the system 500 includes the sensor head 502 configured to be attachable to a wand 507. In both of FIGS. 5A and 5B, the transceiver 110 is configured to be included within the sensor head 502. In some implementations, the system 500 is configured to include a cable 509 for providing data communications between the sensor head 502 and electronics (not shown), such as an electronic storage and an electronic processor, included in a module 511 and/or an electronics housing (not shown). The module 511 is configured to include a speaker 513 or other output, such as a display (not shown) that provides an indication to an operator of the system 500 that a target object has been detected.

In some implementations, the system 500 is configured to include a platform 515 that is sized to fit forearm regions of a human operator or a mechanical portion of a robotic system. In addition, the platform 515 includes a portion that opens on a bottom end 517 to a grip 519. Accordingly, the operator of the system 500 may control the motion and location of the sensor head 502 by grasping or otherwise contacting the grip 519 and moving the wand 507 through a range of motions. In some implementations, the platform 515 is configured to form a portion of an electronics housing 518.

FIG. 5B shows a top view of exemplary components of the sensor head 502, but without a cover overlying the sensor head 502. The sensor head 502 is configured to include a GPR that includes a receive antenna 108 and a transmit antenna 106, the transceiver 110, and a CWMD 505. The GPR may be a stepped-frequency continuous-wave SFCW-GPR (a GPR with a non-pulsed signal). In some implementations, the low-profile of a SFCW-GPR antenna configuration allows a reduction in an overall height and contour of the sensor head 502, making collapse and visual registration with the ground easier for the operator.

In FIG. 5B, the transmit antenna 106 transmits electromagnetic signals within a particular frequency band, and the receive antenna 108 receives (detects or otherwise senses) signals from the surrounding environment that arise in response to being irradiated with the signals from the transmit antenna 106. For example, the frequency band of the GPR may be approximately 640 MHz to approximately 4 GHz, or a frequency band within this frequency range.

In FIG. 1, the transceiver 110 is configured to be a radar transceiver. Accordingly, the transceiver 110 allows for simplified cabling and the elimination of a microwave cable between sensors within the sensor head 502 and electronics (not shown) in a separate part of the detection system. For example, rather than using a coaxial cable or cables, the transceiver 110 is configured to allow for a cable, such as the cable 509 (which may be a USB cable), that provides communication between the GPR and electronics that are removed from the sensor head 502. Accordingly, elimination of the microwave cable results in less power dissipation and reduction in phase mismatch of the signals traveling in the microwave cable.

Implementations of the techniques discussed above may include a method or process, a system or apparatus, a kit, or computer software stored on a computer-accessible medium.

A number of implementations of the techniques have been described. Nevertheless, it will be understood that various modifications may be made without departing from the spirit and scope of the claims.

For example, alternatively, or additionally, another antenna (not shown) having the same chirality as the transmit antenna 106 can be added to receive the receive signal 118. Additional antennas of either chirality can be added to achieve a desired performance of the detection system 100.

Either, or both, of the transmit and receive antennas 106 and 108 may be configured to communicate with the transceiver 110 via an electromagnetic or electrical coupling that is not necessarily a physical connection.

The techniques discussed above may be used in any type of radar system, including ground penetrating radars and wall penetrating radars.

What is claimed is:

1. An apparatus for detecting objects, the apparatus comprising:
a transceiver configured to generate a radar signal;
a transmit antenna coupled to the transceiver and configured to emit the radar signal, the radar signal comprising a first circular polarization; and
a receive antenna coupled to the transceiver and configured to receive a return signal, the return signal comprising the first circular polarization.

2. The apparatus of claim 1, wherein the transmit antenna and the receive antenna are a single antenna.

3. The apparatus of claim 2, wherein the transceiver comprises a directional coupler configured to access the received return signal.

4. The apparatus of claim 3, wherein the directional coupler is configured to access an amplitude and a phase of the received return signal.

5. The apparatus of claim 3, wherein the transceiver is electrically coupled to the transmit antenna through an electrically conductive trace, and the directional coupler comprises an electrically conducting element positioned to be electromagnetically coupled to the electrically conductive trace when current flows through the electrically conductive trace.

6. The apparatus of claim 1, further comprising an additional receive antenna coupled to the transceiver and configured to receive another return signal, the another return signal comprising a second circular polarization different from the first circular polarization.

7. A method of operating a radar system, the method comprising:
generating, by a transceiver, a radar signal;
emitting the radar signal towards a surface, the radar signal comprising a first circular polarization;
receiving a return signal from the object surface, the return signal comprising the first circular polarization; and
identifying, from the received return signal, the presence of a target object, the target object being a substantially asymmetric object located beneath a ground surface.

8. The method of claim 7, wherein the object is a substantially asymmetric object.

9. The method of claim 8, wherein the substantially asymmetric object is a command wire.

10. The method of claim 7, further comprising receiving another return signal from the surface, the received another return signal comprising a second circular polarization opposite from the first circular polarization.

11. A method for detecting asymmetric objects, the method comprising:
accessing, using an electronic processor coupled to a transceiver, data representing radar return signals arising from one or more pulses emitted from a radar system;
analyzing, using the electronic processor, the accessed data to identify a target object;
determining, using the electronic processor and based upon the analyzed accessed data, that the target object is (i) a substantially asymmetric objected is located beneath a ground surface, or (ii) other than a substantially asymmetric objected is located beneath a ground surface; and
in response to determining that the target object is (i) a substantially asymmetric objected is located beneath a ground surface, or (ii) other than a substantially asymmetric objected is located beneath a ground surface, generating, using the electronic processor, an alarm to an operator.

12. The method of claim 11, wherein the data representing radar return signals comprises a ground penetrating radar data packet.

13. The method of claim 11, wherein analyzing, using the electronic processor, the accessed data to determine whether a substantially asymmetric object is located beneath a ground surface comprises:
establishing a threshold based upon the accessed data;
filtering the accessed data based upon the threshold;
filtering the threshold filtered accessed data using a morphological filter; and
presenting the alarm to the operator based upon the morphological filtered, threshold filtered accessed data.

14. The method of claim 11, wherein determining, using the electronic processor and based upon the analyzed accessed data, that the target object is (i) a substantially asymmetric objected is located beneath a ground surface, or (ii) other than a substantially asymmetric objected is located beneath a ground surface comprises:
establishing a threshold based upon the accessed data;
comparing the accessed data with the threshold; and
determining, based upon results of the comparing the accessed data with the threshold, the presence of the target object.

15. The method of claim 14, further comprising:
determining, based upon results of comparing the accessed data with the threshold, that the accessed data is above the threshold;
determining, based upon the determination that the access data is above the threshold, that the target object is a substantially asymmetric object; and
generating, based upon the determining that the target object is a substantially asymmetric object, the alarm to an operator that the target object is a substantially asymmetric objected located beneath a ground surface.

16. The method of claim 14, further comprising:
determining, based upon results of comparing the accessed data with the threshold, that the accessed data is below the threshold;
determining, based upon the determination that the access data is above the threshold, that the target object is not a substantially asymmetric object; and
preventing generation, based upon the determining that the target object is a substantially asymmetric object, of the alarm to the operator that the target object is other than a substantially asymmetric objected located beneath a ground surface.

17. A system, comprising:
one or more computers and one or more storage devices storing instructions that are operable, when executed by the one or more computers, to cause the one or more computers to perform operations comprising:
generating, by a transceiver, a radar signal;
emitting the radar signal towards a surface, the radar signal comprising a first circular polarization;
receiving a return signal from the object surface, the return signal comprising the first circular polarization; and
determining, from the received return signal, whether an object is obscured by the surface.

18. The system of claim 17, further comprising operations of accessing the received return signal using a directional coupler to access an amplitude and a phase of the received return signal.

19. The system of claim 17, further comprising performing operations comprising receiving another return signal using an additional receive antenna coupled to the transceiver, the another return signal comprising a second circular polarization different from the first circular polarization.

20. The system of claim 19, wherein the transceiver is electrically coupled to the transmit antenna through an electrically conductive trace, and the directional coupler comprises an electrically conducting element positioned to be electromagnetically coupled to the electrically conductive trace when current flows through the electrically conductive trace.
